(19) United States
(12) Patent Application Publication
(10) Pub. No.: US 2017/0140250 A1
(43) Pub. Date: May 18, 2017

(54) CONTENT FILE IMAGE ANALYSIS

(71) Applicant: Microsoft Technology Licensing, LLC, Redmond, WA (US)

(72) Inventors: Christopher Michael Maloney, San Francisco, CA (US); Alexander Ivaniukovich, Sunnyvale, CA (US)

(73) Assignee: Microsoft Technology Licensing, LLC, Redmond, WA (US)

(21) Appl. No.: 15/081,351

(22) Filed: Mar. 25, 2016

Related U.S. Application Data
(60) Provisional application No. 62/255,228, filed on Nov. 13, 2015.

(51) Int. Cl. G06K 9/62; G06K 9/20; G06T 7/40; G06F 17/30

(52) U.S. Cl. CPC G06K 9/6267; G06F 17/30112; G06F 17/30274; G06K 9/6212; G06K 9/2054; G06T 7/408; G06T 7/403; G06T 2207/10024; G06T 2210/22

(57) ABSTRACT

Systems, components, devices, and methods for understanding the content of an image are provided. A non-limiting example is a method for generating suggestions for arranging content based on understanding the contents of an image. The method includes the step of receiving a content file that includes a content region and an image. The method also includes the steps of generating a statistical analysis of the image and calculating a score based on the statistical analysis. The method also includes the step of classifying the image based on comparing the score to a threshold value. Additionally, the method includes the step of generating a suggestion for arranging the content region based on the classification of the image.

### CROSS-REFERENCE TO RELATED APPLICATIONS

This application claims priority to U.S. Provisional Application Ser. No. 62/255,228, entitled “CONTENT FILE IMAGE ANALYSIS,” filed on Nov. 13, 2015, the entire disclosure of which is hereby incorporated herein by reference.

### BACKGROUND

Presentation editors work with presentation content files, which often include images. Presentation editors typically do not offer a robust method for placing content, such as images, on slides and it is often challenging for users who create presentations to envision alternatives regarding how to effectively organize slide content. Such organization is vital for conveying a message to the presentation viewer, making effective use of the slide space, and making presentations more visually interesting. Organizing content using current presentation editors may be challenging. For example, some presentation editors simply provide a few slide layouts (also referred to as “slide formats”) from which to choose and only allow users to add content according to the slide format provided. Thus, reorganizing the slide requires selecting a new slide format and re-adding content. Further, presentation editors often simply overlay new content over the existing slide content, which blocks the existing content and may make it more difficult to fit the new content into the existing slide.

It is with respect to these and other general considerations that aspects have been made. Also, although relatively specific problems have been discussed, it should be understood that the aspects should not be limited to solving the specific problems identified in the background.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A non-limiting example is a system and method for generating suggestions for arranging content based on understanding the contents of an image. The method includes the step of receiving a content file that includes a content region and an image. The method also includes the steps of generating a statistical analysis of the image and calculating a score based on the statistical analysis. The method also includes the step of classifying the image based on comparing the score to a threshold value. Additionally, the method includes the step of generating a suggestion for arranging the content region based on the classification of the image.

Aspects may be implemented as a computer process, a computing system or as an article of manufacture such as a computer program product or computer readable media. The computer program product may be computer storage media readable by a computer system and encoding a computer program of instructions for executing a computer process.

### BRIEF DESCRIPTION OF THE DRAWINGS

FIG. 1 is a block diagram of one example of a system for providing suggestions for a content file.

FIG. 2 illustrates an example user interface screen generated by aspects of the content editor of FIG. 1.

FIG. 3 illustrates a method for using suggestions to arrange a content file performed by aspects of the content editor of FIG. 1.

FIG. 4 illustrates a method for generating suggestions for a content file performed by aspects of the suggestion service of FIG. 1.

FIG. 5 illustrates a method for identifying relevant blueprints for a content file based on image analysis performed by aspects of the suggestion service of FIG. 1.

FIG. 6 illustrates a method for determining whether an image is croppable performed by aspects of the image analysis engine of FIG. 1.

FIG. 7 illustrates a method for determining whether an image is a photograph performed by aspects of the image analysis engine of FIG. 1.

FIG. 8 illustrates a method for determining whether an image is a photograph based on counting the number of unique pixels performed by aspects of the image analysis engine of FIG. 1.

FIG. 9 illustrates a method for determining whether an image is a photograph based on calculating an entropy value performed by aspects of the image analysis engine of FIG. 1.

FIG. 10 illustrates a method for identifying an invariant region within an image performed by aspects of the suggestion service of FIG. 1.

FIG. 11 is a block diagram illustrating example physical components of a computing device with which aspects of the invention may be practiced.

FIGS. 12A and 12B are block diagrams of a mobile computing device with which aspects of the present invention may be practiced.

FIG. 13 is a block diagram of a distributed computing system in which aspects of the present invention may be practiced.

### DETAILED DESCRIPTION

Various aspects are described more fully below with reference to the accompanying drawings, which form a part hereof, and which show specific exemplary aspects. However, aspects may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

The present disclosure describes systems and methods for suggesting arrangements of content elements within content files based on image analysis. Among other benefits, the disclosed technology may allow users to more quickly create aesthetically pleasing content files that effectively convey information and efficiently use space within the content file.

Content editors are used to create and edit content files. There are various types of content editors to edit various types of content files. Content files may include a plurality of content regions that can be consumed visually with an appropriate viewing tool. The content regions may include arrangements of content elements such as images, media, text, charts, and graphics.

For example, a presentation editor such as the POWERPOINT® presentation graphics program from Microsoft Corporation of Redmond, Wash. is used to edit presentation content files. Typically, presentation content files comprise one or more content regions in the form of slides or portions of a canvas. Additional examples of content editors include document editors such as the WORD document editing program from Microsoft Corporation of Redmond, Wash., which is used to edit document content files and spreadsheet editors such as the EXCEL® spreadsheet editing program also from Microsoft Corporation, which is used to edit spreadsheet content files. Like the presentation content files, other types of content files may also include arrangements of various content elements within content regions (e.g., pages or sections of a document content file, or sheets of a spreadsheet content file, etc.). The above listed content editors are examples and many other types of content editors are used to edit other types of content files as well. In some examples, content files are formatted with an Office Open XML File format, such as the Office Open XML Document format (which will often have a .DOCX extension), the Office Open XML Presentation format (which will often have a .PPTX extension), or the Office Open XML Workbook format (which will often have a .XLSX extension). Other formats for content files are possible as well.

In examples, a content editor presents suggestions regarding how to arrange content elements within a content region of a content file. These suggestions may be based on analyzing one or more images within the content region or that are being added to the content region.

For example, a content editor may present one or more suggestions for arrangements of content elements within a content region. The suggestions may be presented visually (e.g., as thumbnail images of the content regions after application of the suggestion) in a user interface generated by the content editor. In some aspects, one or more suggestions are presented in a region adjacent to an editing pane of a user interface generated by the content editor. The suggestions are ordered based on the predicted suitability of the suggestion for the content region (e.g., based on the content in the content region, themes or other design elements that have been applied to the content region, previously selected suggestions, etc.). Alternatively, the suggestions are ordered according to a different criterion or only a single suggestion is presented.

A user can then provide an input to select one of the presented suggestions (e.g., by touching/clicking on the visual presentation associated with the suggestion). In response, the content editor applies the selected suggestion to the content region. In some aspects, the selection is recorded and may be used to influence the generation of suggestions in the future (e.g., suggestions similar to previously selected or frequently selected suggestions may be scored higher and may be more likely to be presented to users).

The content editor may present suggestions in response to a triggering event. An example of a triggering event is the user adding an image to a content region. When the image is added, the image may be placed in an initial position and then suggestions may be generated. Another example triggering event is a user actuating a user interface element (e.g., a suggestions button) to indicate that suggestions should be provided. Further, in some aspects, the user editing a property of an image is a triggering event as well. For example, a user may crop an image that has been added to a content region and in response suggestions may be generated based on the cropped image. Other alterations of an image may also trigger the generation of suggestions.

In some aspects, the content editor is a component of a client computing device that interacts with a suggestion service of a server computing device. The content editor may send the content file or a portion of the content file to a suggestion service over a network. The suggestion service may then respond by sending suggestions to the client computing device. Alternatively, the suggestion service may operate on the client computing device and may even be integral with the content editor.

In some aspects, the suggestions are generated by selecting relevant blueprints and applying the selected blueprints to the content region. In some aspects, the blueprints comprise content files. In this case, the blueprint content files may include tags that identify positions in a content region for content elements and properties/characteristics for adding content elements to the blueprint. The tags may be included in a portion of the content file that is configured to store tags. However, some content file formats do not include a portion configured to store tags. In these cases, the tags may be stored in an existing portion of the file. For example, the tags may be stored in a textual field associated with a content region (e.g., a notes field) or in a textual field associated with a content element (e.g., an alternate text field). A textual field may, for example, be a field that is configured to store text data. In this manner, existing content file formats can be used to store blueprints without requiring modification to the format. As an example, a tag associated with a placeholder image or shape in a blueprint may indicate that the placeholder should be replaced with an image from the original content file and that the image should be cropped. The placeholder image may have certain properties such as a height, width, aspect ratio, etc. As another example, a tag associated with a shape in the blueprint may indicate that the shape represents an area of focus within the shape or within a separate placeholder shape or image.

The suggestion service may select blueprints to use in generating the suggestions based on assessing a match between the image (as well as other content elements) in the content region and the content elements and tags in the blueprint. For example, if an image in the content region is croppable and larger than the dimensions of a placeholder image on the blueprint, the blueprint may be more likely to be identified as a good match. Conversely, if an image in the content region is smaller than the placeholder image or is determined to be uncroppable, the blueprint may be less likely to be identified as a good match. Similarly, if a salient region (e.g., an area of interest) in an image from the content region is approximately the same size as the shape that is tagged as an area of focus on the blueprint, the blueprint may be more likely to be selected as a good match. The determination of a salient region and whether an image is croppable may be made by performing image processing techniques to analyze the content of the image, or by reading metadata associated with the image, or by other methods as well.

Various factors may be analyzed to determine whether an image is croppable. Some aspects determine that non-photographic images (e.g., charts, clip art, etc.) are not croppable. Some aspects determine whether an image is a photograph based on calculating the number of unique colors appearing in the image (or in a sample of pixels from the image). Alternatively, some aspects calculate an entropy value for the image.

Additionally, some aspects determine that certain types of photographs (e.g., a vignette photograph or a photograph with a text overlay) also cannot be cropped. As an example, a vignette photograph may comprise a subject over a uniform white or transparent background, such as may be found in product photographs. If a vignette photograph is cropped, a portion of the subject may be cropped and the resulting edge may look unnatural. Similarly, when a photograph with a text overlay is cropped a portion of the text overlay may be cropped, which may impair the communicative value of the image. Beneficially, by determining that vignette photographs and photographs with text overlays are not croppable, suggestions that could include these potentially unsatisfying results are avoided.

Additionally, the suggestion service may select blueprints based on the compatibility of the blueprint and a characteristic of the content region (e.g., a theme, color scheme, style, etc.). Other factors may also be used to select blueprints. For example, the amount of text or the organizational structure of text included in the content region may influence which blueprints are selected (e.g., a blueprint designed to highlight a bulleted list may be more likely to be selected for a content region that includes a bulleted list).

In some aspects, photograph images are further analyzed to identify regions over which text may be placed so that the text will likely be easy to see and read. For example, the photograph image may be analyzed to identify invariant regions. An example invariant region is a region of the image that is similar in at least one property (e.g., pixels in the region have a similar brightness or luminance value, pixels in the region have a similar color value, pixels in the region have a similar value for at least one component, etc.). Additionally, when an invariant region is identified, one or more suggested color values may be identified for use in text or other overlays on the invariant region. In some aspects, the suggested color values are selected to stand out from or contrast with the invariant region. Beneficially, text overlaid on the invariant region using the suggested color values is likely to stand out and be easy to read.

Further, in some aspects, photograph images are analyzed to identify and remove borders prior to including the image in suggestions. After the border is removed, the remaining image may be analyzed to determine whether it is croppable as has been previously described. The border may be a single uniform color, or may include some variations or additional information such as textual information about the image. For example, the textual information may identify the image in a catalog of images. In some aspects, alternate (but similar) photograph images may be included in suggestions as well, based on analyzing the image to determine the content. The alternate images may be better suited for the suggestion for a variety of reasons (e.g., higher resolution, color palette fits the blueprint or theme better, includes an invariant region for text overlays, more desirable licensing terms, etc.).

In some aspects, a non-photograph image is further analyzed to determine whether the image includes a chart. If the analysis determines that the image does include a chart, the image may be further analyzed to extract the data the chart represents. The analysis may include text extraction (e.g., optical character recognition). Alternatively or additionally, the analysis may include determining the size or position of various representative graphical elements (e.g., bars or columns in a bar graph, dots or other markers in a scatter plot, lines in a line chart, slices in a pie chart, etc.). Once the data is extracted, it may be stored in a table and used to produce a corresponding native-format chart. An example of a native-format chart is a chart generated by the content-editing application based on the data extracted from the image of the charts. Additionally, in some aspects, suggestions are generated that include a native-format chart in a different style or color scheme. Advantageously, by generating a native-format chart, the chart may be reformatted in many different ways that would not be possible through image manipulation (e.g., a bar chart could be turned into a line chart, the color scheme can be changed, the data in the chart can be filtered or scaled, etc.).

In some aspects, image processing is performed to detect whether an image comprises a logo such as a company or brand logo. If so, at least some of the suggestions that are generated are based on determining that the image is a logo. For example, in some suggestions, the image of the logo is disposed in the lower right corner of the content region.

Although the examples herein typically relate to a presentation editor on a client computing device interacting via a network with a suggestion service on a server computing device, other aspects are possible as well. For example, aspects that include other types of content editors are possible as well. Additionally, some aspects include a presentation editor on a server computing device or a suggestion service on a client computing device.

Further, although many of the examples herein relate to using image processing to generate suggestions for content regions within content files, other aspects use image processing for other purposes. For example, in some aspects, the techniques disclosed herein are used to classify images for search applications such as a web search, web crawler, or a local search. Further, in some aspects, the techniques disclosed herein are used to automatically analyze web pages, blogs, and social media content.

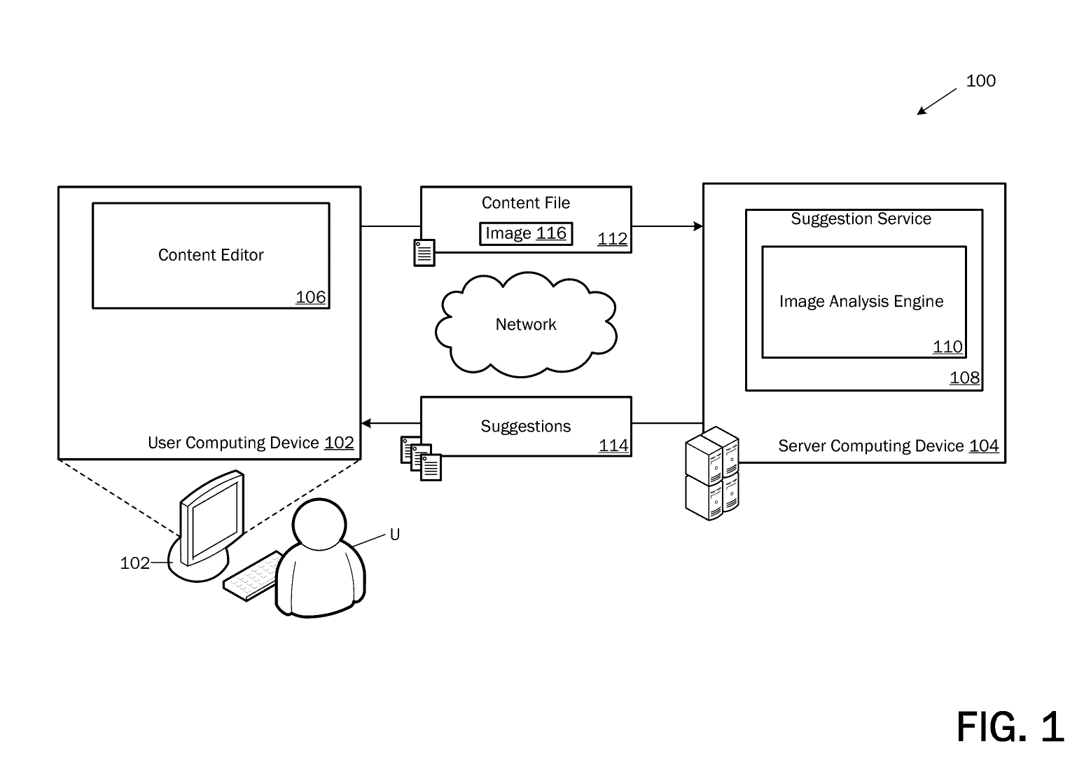

FIG. 1 is a block diagram of one example of a system 100 for providing suggestions for a content file. As illustrated in FIG. 1, the system 100 includes a user computing device 102 that is operable by a user U and a server computing device 104. The user computing device 102 and the server computing device 104 communicate over a network.

The user computing device 102 includes a content editor 106. In the example shown in FIG. 1, a content file 112 is transmitted by the user computing device 102 to the server computing device 104. In the example shown, the content file 112 includes an image 116.

In some aspects, the content editor 106 is an application running on the user computing device 102 that is operable to create or edit content files, including adding or editing images in the content files. Additionally, in some aspects, the content editor 106 interacts with the server computing device 104. In some examples, the content editor 106 is a browser application operable to generate interactive graphical user interfaces based on content served by a remote computing device such as the server computing device 104 or another computing device. According to an example, an extension is installed on the user computing device 102 as a plug-in or add-on to the browser application (i.e., content editor 106) or is embedded in the browser application.

In an example, the content editor 106 is a presentation editor that operates to generate, edit, and display presentations that include images. The POWERPOINT® presentation graphics program from Microsoft Corporation of Redmond, Wash. is an example of a presentation editor. Other example presentation editors include the KEYNOTE® application program from Apple Inc. of Cupertino, Calif.; GOOGLE SLIDES from Google Inc. of Mountain View, Calif.; HAIKU DECK from Giant Thinkwell, Inc. of Seattle, Wash.; PREZI from Prezi, Inc. of San Francisco, Calif.; and EMAZE from Visual Software Systems Ltd. of Tel-Aviv, Israel. In other examples, the content editor 106 is a document editor such as the WORD document editor from Microsoft Corporation of Redmond, Wash. or a spreadsheet editor such as the EXCEL® spreadsheet editor, also from Microsoft Corporation.

The server computing device 104 includes a suggestion service 108. The suggestion service 108 includes an image analysis engine 110. In the example shown in FIG. 1, suggestions 114 are transmitted by the server computing device 104 to the user computing device 102.

In some aspects, the suggestion service 108 operates to receive a content file 112 from the user computing device 102 and to provide suggestions 114 in response. The suggestion service 108 may comprise one or more applications that are run by the server computing device 104.

For example, in some aspects, the suggestion service 108 operates to receive a presentation file from the user computing device 102. The suggestion service 108 then analyzes at least a portion of the presentation file and transmits to the user computing device 102 suggestions for the layout or design of portions of the content file. For example, the content editor 106 may trigger a transmission of the content file 112 to the suggestion service 108 when an image is added to a slide in a presentation file. The suggestion service 108 may then analyze the image using the image analysis engine 110 to provide suggestions 114. Upon receiving the suggestions 114, the content editor 106 may present to the user U thumbnails based on the suggestions 114. The user U can make a selection and indicate to the content editor 106 to apply the selected suggestion to the content file 112.

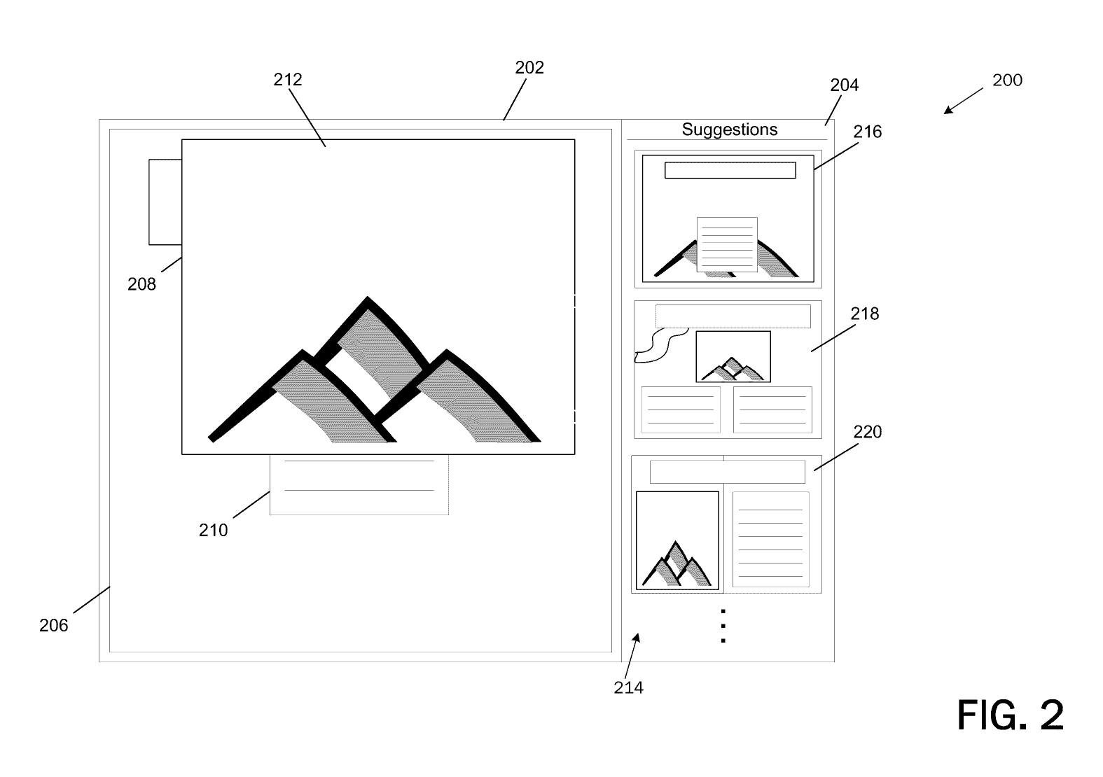

FIG. 2 illustrates an example user interface screen 200 generated by aspects of the content editor 106 and displayed by the user computing device 102. In this example, the screen 200 includes a content region display area 202 and a suggestion display area 204.

The content region display area 202 operates to display one or more content regions from a content file. In some aspects, a user can interact with and modify the content region that is displayed by adding, removing, repositioning, or otherwise modifying various content elements that are displayed in the content region display area 202.

In this example, the content region display area 202 displays a slide 206 from an example presentation content file. The slide 206 includes a header region 208, a list region 210, and an image 212. The image 212 has been recently added to the slide 206 by a user, but has not yet been positioned to fit well with the other content elements. Instead, the image 212 occludes the header region 208 and the list region 210. This exemplary positioning of image 212 may be typical of the initial positioning of newly added images.

Although the image 212 is shown in the upper-right corner of the slide 206 in this example, in some aspects, the initial placement of the image 212 may be placed elsewhere on the slide 206. For example, the initial placement of image 212 may depend on various factors such as, but not limited to, whether the image 212 is being inserted into a content placeholder (i.e., a predefined area of the slide 206), a position of the content placeholder, a type of content placeholder, a size of the content placeholder, and a size of the inserted image.

The suggestion display area 204 comprises a list 214 of suggestions for the slide 206. In this example, the list 214 includes a first suggestion 216, a second suggestion 218, and a third suggestion 220. Other aspects include fewer or more suggestions. The suggestions are shown as thumbnails, which, upon being selected, cause the slide 206 to be arranged in accordance with the suggestion. Although thumbnails are discussed, one skilled in the art may envision various alternative methods of displaying generated suggestions, such as in a new window, in a drop down menu, nested within a ribbon in the application, etc.

The suggestion display area 204 is shown as a vertical bar on the right side of the screen 200. However in other aspects, the suggestion display area 204 is shown as a drop down menu or a separate window or is placed horizontally above or below the content region display area 202. Still further, the suggestion display area 204 may be located elsewhere.

In some aspects, after the user adds the image 212 to the slide 206, the content editor 106 automatically sends the presentation content file or a part thereof (e.g., the slide 206) to the suggestion service 108 on the server computing device 104. In response, the suggestion service 108 sends back the list 214 of suggestions. The list 214 of suggestions may be ordered based on a predicted likelihood the suggestion will be selected (e.g., the suggestion service 108 may calculate scores for each of the suggestions based on how well the content region fits the suggestion). For example, the suggestion shown at the top of the list may be predicted to be the most likely to be selected. Alternatively, the suggestions may be ordered otherwise as well.

The suggestions may include various arrangements of the content elements of the slide 206. The suggestions may include variations of content size, content position, content type, number of content placeholders, suggested content, background, or other properties of the slide. Content design suggestions may be based on analysis of content on the slide 206 including the image 212, content on the previous or next slide, content within the entire content file, a theme associated with the content file, user history data, user preferences, rules or heuristics about types of content, or other data. In some aspects, the suggestions are generated using blueprints that may be selected based on at least some of the above-mentioned factors as well as other factors.

For example, the suggestions may include arrangements of text, images, charts, video, or any combination thereof. In the example of FIG. 2, the first suggestion 216 includes the image as a full sized background with the header and list overlaid thereon, the second suggestion 218 includes the image centered on the slide with the header positioned above and the list divided in two parts below, and the third suggestion 220 includes a cropped version of the image on the left side of the slide with the header positioned above it and the list positioned to the right of it. In some aspects, the third suggestion 220 is generated based on the image analysis engine 110 determining that the image 212 is croppable. The first suggestion 216, the second suggestion 218, and the third suggestion 220 are just examples. And many other suggestions are possible as well. For example, some suggestions may crop the image differently or add various content elements to accentuate the image or a portion of the image. In some aspects, the number of suggestions depends on the content that is inserted, the content that is already on the slide, the content on other slides in the same content file, user history with the content, and/or the preferences of the user.

In some aspects, the suggestion service 108 may analyze the content and thereafter provide additional design suggestions for displaying other content on a slide. For example, if a slide includes statistics in the form of text, the presentation application may analyze the data and provide alternative means of displaying these data on a slide, such as in the form of a graph. As an example, if a quadratic equation had been entered in a text content placeholder, then a content design suggestion may include a chart of a parabola. The suggestion service 108 may query a search server for additional content of the same or of a different content type to display with or instead of the content. Alternatively or additionally, the suggestion service 108 may retrieve related, supplemental data from a repository or a database and insert additional data not included on the slide. For example, the presentation application may include additional statistics, related to content inserted on the slide that is retrieved from a database. As another example, if a user added an image of a beach, the suggestion service may analyze this image with the image analysis engine 110 and generate suggestions that incorporate alternative pictures of beaches retrieved from a database. Hence, the suggestions may be used to supplement content on a slide or used to entirely replace content on a slide.

Further, in some aspects, the suggestion service 108 generates suggestions that include textual elements disposed in an invariant region of the image 212 as identified by the image analysis engine 110. As an example, a portion of the sky may be identified as an invariant region in a landscape photograph. Additionally, the suggestion service 108 may present the textual element in a color that is determined to stand out from the identified invariant region by the image analysis engine 110. Continuing the landscape example, if an invariant region is identified in a landscape photograph as a portion of light blue sky, the suggestion service 108 may generate a suggestion that includes a dark colored textual element overlaid on the sky portion of the image.

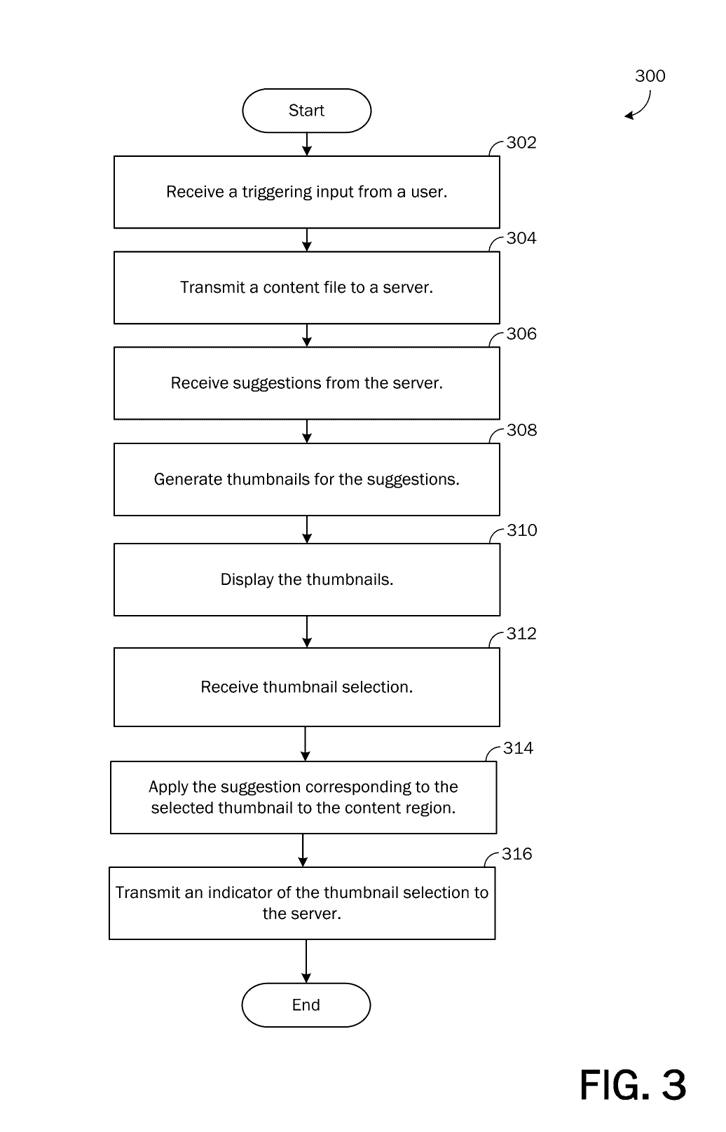

FIG. 3 illustrates a method 300 for using suggestions to arrange a content file. As an example, the method 300 may be executed by a component of an exemplary system such as the system 100. For example, the method 300 may be performed by the content editor 106 to receive and use suggestions from the suggestion service 108. In examples, the method 300 may be executed on a device comprising at least one processor configured to store and execute operations, programs, or instructions.

At operation 302, a triggering input is received from a user. Various aspects include various types of triggering inputs. An example triggering input is an image being inserted into a content region of a content file. Additionally, in some aspects, receiving an input to modify a property of an image (e.g., a crop setting) in a content region is a triggering event. Another example triggering input is another type of content element being inserted into a content region of a content file. Yet another example of a triggering input is a user actuating a user-actuatable control (e.g., a button or menu option to request suggestions). Further, in some aspects, any modification to the content, including the arrangement of the content, within a content file is a triggering event. In these aspects, suggestions are continuously provided as the user creates and edits the content region.

At operation 304, the content file is transmitted to the server computing device 104. In some aspects, the entire content file is transmitted. In other aspects, a portion of the content file is transmitted such as the content region (e.g., a slide, a page, a sheet) that was affected by the triggering event. Because many triggering events may occur while a user is editing a content file with the content editor 106, some aspects transmit portions of the content file that have changed since a prior triggering event to the server computing device 104. Beneficially, at least some of these aspects reduce the amount of data that must be transmitted over the network and reduce the amount of time required for suggestions to be received.

At operation 306, suggestions are received from the server computing device 104. The suggestions may be generated by the suggestion service 108. As described herein, in some aspects, the suggestions are generated using the image analysis engine 110. Various numbers of suggestions may be received. In some aspects, the suggestion service 108 determines a number of suggestions to return to the content editor 106. For example, the suggestion service 108 may return a predetermined number of suggestions. Additionally or alternatively, the suggestion service 108 may return suggestions that exceed a predetermined relevance threshold (e.g., based on a calculated score for relevance or suitability for the content region and/or content file). Additionally, in some aspects, the content editor 106 specifies a number of suggestions to return. Additionally, the server may not return any suggestions if the suggestion service 108 is unable to generate any relevant suggestions.

In one example, the received suggestions comprise lists of actions to perform on the content region to arrange the content elements in accordance with the suggestion. In other aspects, the received suggestions may comprise content files or partial content files containing the content region to which the suggestion pertains.

At operation 308, thumbnails are generated for the suggestions. In some aspects, the thumbnails are generated by applying the list of actions to a copy of the content region and then generating an image of the updated copy of the content region. Alternatively, if the received suggestions comprise updated content regions, the updated content regions may be rendered and used to generate the thumbnail images.

At operation 310, the generated thumbnails are displayed. In some aspects, thumbnails for all of the received suggestions are displayed. In other aspects, thumbnails for a portion of the suggestions are displayed. For example, a slider or other type of user-actuatable control may be provided to allow a user to request that thumbnails for additional suggestions be displayed.

At operation 312, a thumbnail selection is received. For example, the selection may be received when a user touches, swipes, clicks, or double-clicks on one of the thumbnails. In other aspects, a user may indicate a selection by actuating a user interface element.

At operation 314, the suggestion corresponding to the selected thumbnail is applied to the content region of the content file. By applying the suggestion to the content region, the content region is arranged in accordance with the suggestion. In some aspects, the content elements from the suggestions are copied or merged into the content region. Additionally or alternatively, a series of actions are applied to the content region to transform the content region to match the selected thumbnail.

At operation 316, an indication of the selection is sent to the server computing device 104. The server computing device 104 may store this information to generate usage statistics for the suggestions. As mentioned previously, the suggestions may be generated using blueprints. In some aspects, the usage statistics are generated for the blueprints. Additionally, in some aspects the usage statistics are generated for subsets of the received content files based on properties of the content file. For example, the usage statistics may be generated separately for content regions that include a bulleted list and content regions that include a paragraph of text. Additionally, the statistics may be calculated in a manner that incorporates information about the user. For example, statistics may be generated for a specific user, multiple users who are associated with a particular organization, or users who are associated with a certain region. The usage statistics may be used by the suggestion service 108 to adjust the model used for selecting blueprints for use in generating suggestions.

In some aspects, once a thumbnail is selected and applied to a content region, the other thumbnails are no longer displayed. Alternatively, the other thumbnails remain visible after the selection is received so that a user may change the selection.

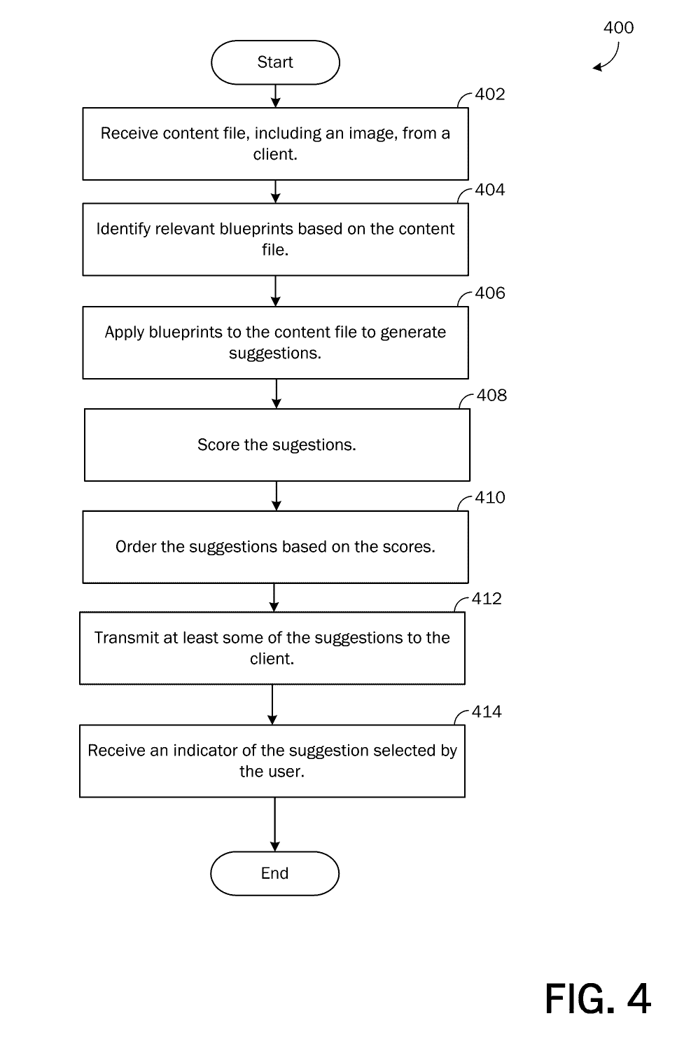

FIG. 4 illustrates a method 400 for generating suggestions for a content file that includes an image. As an example, the method 400 may be executed by a component of an exemplary system such as the system 100. For example, the method 400 may be performed by the suggestion service 108 to generate and transmit suggestions to the content editor 106. In examples, the method 400 may be executed on a device comprising at least one processor configured to store and execute operations, programs, or instructions.

At operation 402, a content file that includes an image is received from a client such as the user computing device 102. In some aspects, the entire content file is received. In other aspects, a content region containing the image is received. Additionally, in some aspects, the image is identified as being recently added to the content region. The image may be disposed in an initial position within the content region such as overlaying and occluding other previously added content elements. Further, in some aspects, the image may be added, but not yet positioned within the content region.

At operation 404, relevant blueprints are identified based on the content file and the content elements therein. Various factors may be used to determine that a blueprint is relevant. For example, relevant blueprints may be associated with or compatible with a theme that has been applied to the content region. Additionally, relevant blueprints may include placeholders that correspond well to the content elements on the slide (e.g., the same number of placeholders as content elements, placeholders with compatible dimensions, etc.). Additionally, a blueprint may be identified as relevant based on matching a determined property of a content element of the content file (e.g., a particular blueprint may be more appropriate for content elements that include images of charts). In some aspects, the image analysis engine 110 analyzes an image included in the content file to determine various properties of the image that may then be used to identify relevant blueprints (e.g., whether the image is a photograph, whether the image is croppable, whether the image includes a vignette, border, or text overlay; whether the image includes a chart, whether the image includes an invariant region that would be good for displaying text, etc.).

At operation 406, the identified relevant blueprints are applied to the content file to generate suggestions. In some aspects, the content elements of the content region are mapped to placeholder content elements in the blueprint. For example, a title text within the content file may be mapped to a title placeholder in the blueprint. Similarly, an image content element from the content region may be mapped to an image placeholder. Depending on the dimension of the image and the placeholder, as well as the results of any image analysis performed by the image analysis engine 110, the image may be cropped or resized to fit the placeholder. Additionally, the image may be positioned so that a salient region of the image is disposed within an identified focus area on the blueprint.

At operation 408, the generated suggestions are scored. In some examples, the suggestions are scored based on a predicted likelihood that the suggestion would be selected by a user. The scores may be based on a variety of factors. For example, blueprints that are associated with the same theme as the content region may be scored higher than otherwise equal blueprints that are not associated with the same theme as the content region. Additionally, blueprints that require less modification (e.g., cropping or resizing) of the images included in the content region may be scored higher than blueprints that require more modification. A blueprint that has a defined focus region that aligns with a salient region of an image content element from the content region may score higher than a blueprint that does not include a focus area or a blueprint that includes a focus area that does not align well with a salient region of a content element of the content region. Additionally, the score may be based on a popularity of the blueprint with the user, an organization the user is associated with, or the general public (e.g., as determined by previous selections). Further, the score may be based on similarity between the blueprint and other blueprints that have been previously applied to other content regions of the content file.

At operation 410, the suggestions are ordered based on the scores. At operation 412, at least some of the suggestions (e.g., the highest scoring suggestions) are transmitted to the content editor 106. The suggestions may be transmitted in a number of ways. For example, the suggestions may be transmitted as multiple lists of steps that when applied will transform the content region according to the suggestion. Alternatively, the suggestions may be transmitted as an updated content region that has had the suggestion applied.

At operation 414, an indicator of the suggestion selected by the user is received. For example, the content editor 106 may transmit a message containing an indicator of the user's selection. As described previously, the selection may be stored and used to generate usage statistics that may be used to improve the way suggestions are generated in response to future requests.

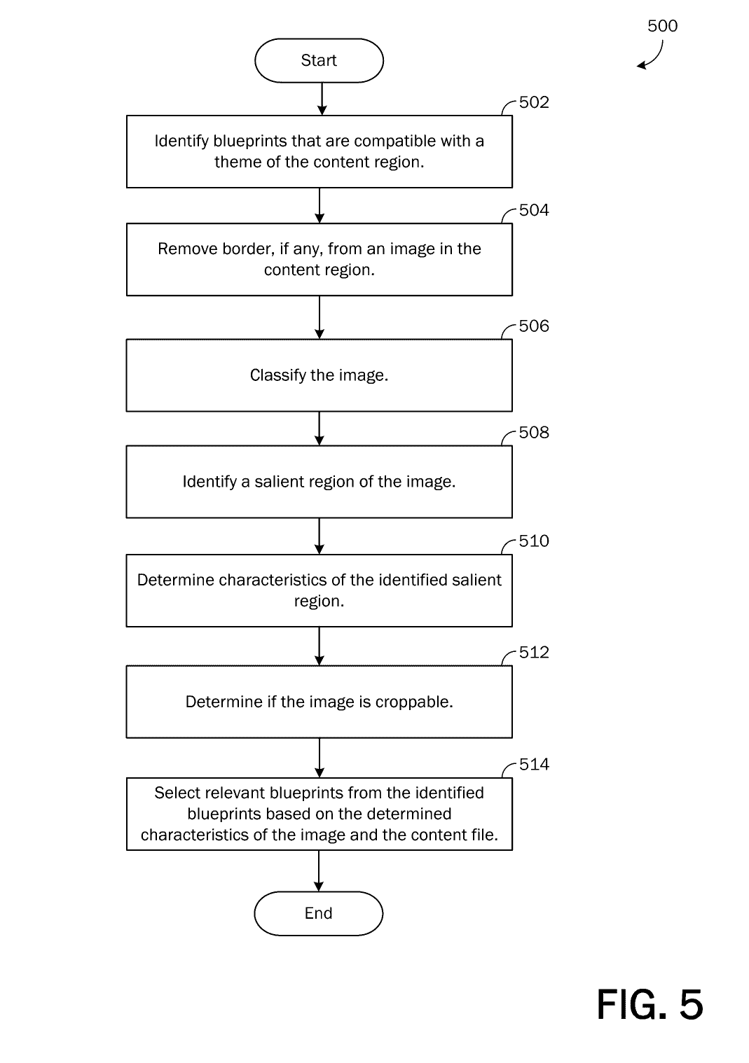

FIG. 5 illustrates a method 500 for identifying relevant blueprints for a content file based on image analysis. As an example, the method 500 may be executed by a component of an exemplary system such as the system 100. For example, the method 500 may be performed by the suggestion service 108 to generate and transmit suggestions to the content editor 106. In examples, the method 500 may be executed on a device comprising at least one processor configured to store and execute operations, programs, or instructions.

At operation 502, blueprints that are compatible with a theme of the content file are identified. In some aspects, a theme comprises a pattern for a slide or group of slides and may include layout elements (e.g., placeholders for titles, headers, lists, footers, and other types of content), colors, fonts, shapes, images, and background styles and images. A theme may be applied to all content regions within a content file or a subset of the content regions. Some content files may include multiple themes such that different content regions are associated with different themes.

In aspects, blueprints may be theme-specific or generally applicable. Theme-specific blueprints are designed for one or more particular themes. Generally-applicable blueprints are designed to be compatible with any or nearly any theme. In some aspects, the blueprints include metadata that identify whether the blueprint is theme specific and further which themes the blueprint is compatible with. In some aspects, when the blueprint is stored using an existing format for a content file, the metadata are stored in and extracted from text fields in the blueprint files (e.g., a notes field associated with a content file or a content region in the content file). Additionally, in some aspects, when the blueprints are stored using an existing format for content files, the blueprints can have a theme applied in a similar manner to any other content file. In some aspects, blueprints are identified by searching for blueprints that include metadata indicating that the blueprint is associated with the theme of the content region. In aspects, depending on how many theme-specific blueprints are identified, generally-applicable blueprints may be identified as well. Additionally, in some aspects, blueprints are identified by searching for blueprints having the same theme as or a similar theme to the theme of the content region for which suggestions are being generated.

In some aspects, the suggestion service 108 may use a table or index to identify blueprints that are compatible with particular themes. In these aspects, the suggestion service 108 queries the table or index for blueprints compatible with the theme of the content region for which suggestions are being generated. Additionally or alternatively, the blueprints may be organized in a hierarchical structure such as a directory structure that indicates the themes with which the blueprints are compatible (e.g., a first directory containing blueprints that are compatible with a first theme, a second directory containing blueprints that are compatible with a second theme, and third directory containing blueprints that are generally applicable, etc.). In these aspects, the blueprints may be identified by determining an appropriate directory and identifying the blueprints contained therein.

At operation 504, a border, if any, of an image in the content region is removed. Various image processing techniques may be used to detect and remove the border. For example, the border may be detected by evaluating the number of unique colors present in one or more rows or columns of pixels that are in proximity to the edges of the image. If a single color or a small number of colors are found, it may be determined that the image has a border. After a border region is initially detected, the full size of the border may be determined by evaluating additional rows or columns until additional colors are identified. The identified border may then be removed using cropping techniques.

At operation 506, the image from the content region for which suggestions are being generated is classified. In some aspects, multiple images may be classified. If a border has been removed from the image in operation 504, the remaining portion of the image may be classified. Classifying the image may comprise determining whether the image is a photograph or graphic (e.g., a chart, clip art, screenshot, etc.). In later operations, the results of this classification may be used to select appropriate blueprints. For example, some blueprints may fit well with a chart, while others may fit well with a photograph. Various techniques may be used to classify the image. For example, image processing techniques may be used to analyze some or all of the pixels of the image to classify the image. In some aspects, the image may include metadata that are evaluated to determine or influence the determination of a content type (e.g., an image that includes metadata specifying a camera make and model may be indicative of the image being a photograph).

At operation 508, the salient region of the image is identified. In some aspects, the salient region comprises a portion of the image that is most important (e.g., most prominent or noticeable). For example, a face may be identified as a salient region of an image of a person. The salient region may comprise a single contiguous region. Alternatively, the salient region may comprise multiple contiguous regions. Various image analysis techniques may be used to identify the salient region. For example, facial recognition techniques may be used to identify a portion of an image containing a face. Other techniques may be used as well, such as by identifying regions of high contrast or high variation, regions containing text, foreground regions, etc.

At operation 510, characteristics of the identified salient region are determined. For example, in some aspects, the height, width, and aspect ratio of the salient region are determined. Further, other aspects may determine other characteristics of the salient region as well.

At operation 512, it is determined whether the image is croppable. For example, an image may be croppable if it is determined that a portion of the image can be removed (or hidden). The image may be cropped to remove an outer portion, such as a horizontal strip along the top or bottom of the image or a vertical strip along one of the sides. In some aspects, an image is determined to be croppable based on metadata associated with the image or a setting parameter specified by the content editor 106. Additionally, in some aspects, an image is determined to be croppable if it is a photograph and a portion of the image can be removed without affecting the identified salient region. Further in some aspects, a photograph is determined to be not croppable if the photograph is a vignette or includes a text overlay. Alternatively, the presence of a text overlay or a vignette may influence the determination of how to crop the image (e.g., the image may be cropped so long as only the uniform region of the vignette is affected or so long as the text overlay is not cropped).

At operation 514, relevant blueprints are selected from the identified blueprints based on the determined characteristics of the image and the content file. For example, blueprints that have an image placeholder of the same or similar size to the image may be selected. Additionally, if the image is croppable, additional blueprints having image placeholders that have a size to which the content element can be cropped may be selected as well. In some aspects, the amount of text or presence of a bulleted list may also be used in selecting blueprints from the identified blueprints. In various aspects, various numbers of blueprints are selected.

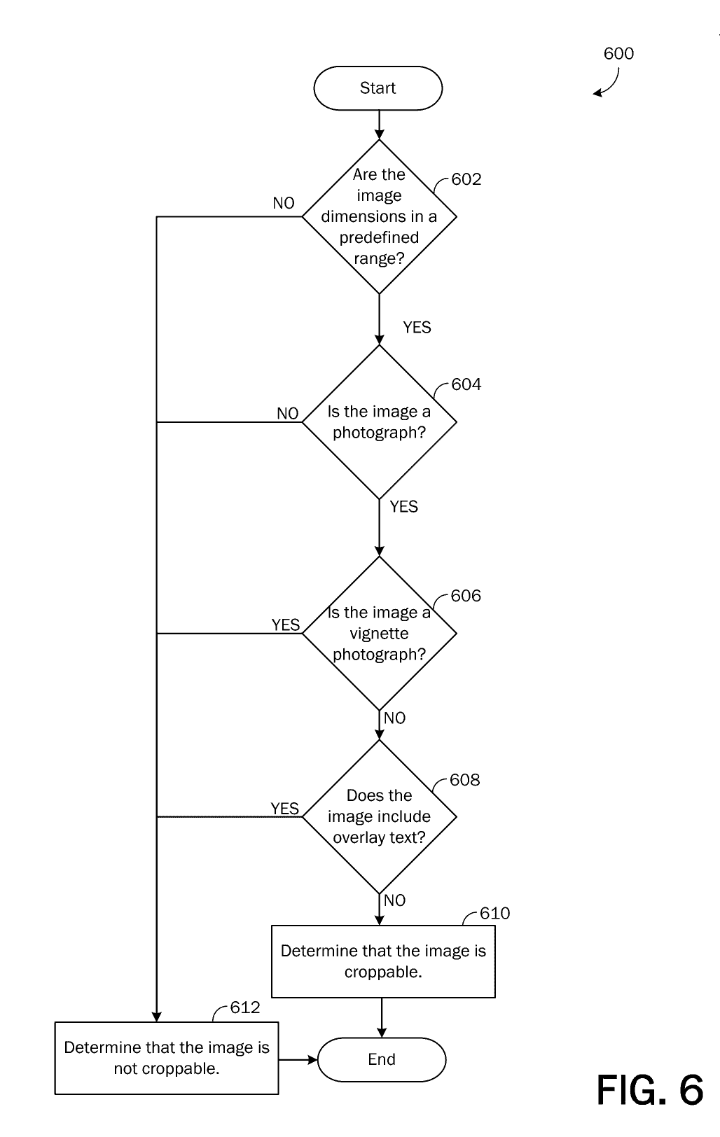

FIG. 6 illustrates a method 600 for determining whether an image is croppable. As an example, the method 600 may be executed by a component of an exemplary system such as the system 100. For example, the method 600 may be performed by the image analysis engine 110 to determine whether an image being analyzed should be cropped. In examples, the method 600 may be executed on a device comprising at least one processor configured to store and execute operations, programs, or instructions.

At operation 602, it is determined whether the image dimensions are in a predefined range. In some aspects, the predefined range includes all images having a width greater than or equal to a minimum width and a height greater than or equal to a minimum height. For example, the minimum width may be 500 pixels and the minimum height may be 500 pixels. In some aspects, the minimum width is larger or smaller and the minimum height is larger or smaller. Additionally, in some aspects, the predefined range also includes a maximum height and maximum width. Further, in some aspects, the predefined range is defined based on the dimensions or other properties of a placeholder image (e.g., in a blueprint). If the image dimensions are within the predefined range, the method proceeds to operation 604. If not, the method proceeds to operation 612, where it is determined that the image is not croppable.

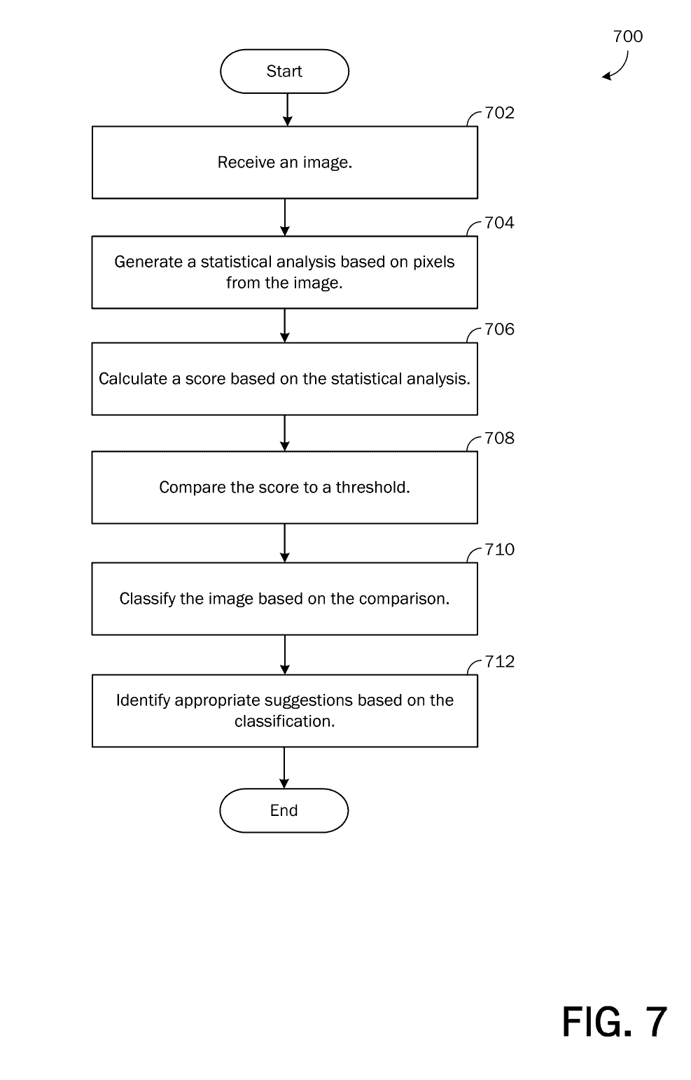

At operation 604, it is determined whether the image is a photograph. Various image processing techniques may be used to determine whether the image is a photograph. Examples of determining whether an image is a photograph are illustrated and disclosed with respect to at least FIGS. 7-9. If it is determined that the image is a photograph, the method proceeds to operation 606. If not, the method proceeds to operation 612, where it is determined that the image is not croppable.

At operation 606, it is determined whether the image is a vignette photograph. As described previously, in examples, a vignette photograph may comprise a subject over a uniform white or transparent background, such as may be found in a product photograph. In some aspects, it is determined that the image is a vignette photograph based on detecting a non-uniform shaped border region in which the pixels all share a common color value. If it is determined that the image is a vignette photograph, the method 600 proceeds to operation 612, where it is determined that the image is not croppable. If not, the method 600 proceeds to operation 608.

At operation 608, it is determined whether the image includes a text overlay. In some aspects, determining whether the image includes a text overlay comprises using optical character recognition techniques. Additionally, in some aspects, additional processing is performed to determine whether the output of the optical character recognition comprises overlay text (as opposed to text on a photographed object such as a sign or a shirt). For example, one or more of the following properties may be determined: the orientation of the characters, the uniformity of color or pattern on the characters, whether shadows overlay the characters, and whether objects from the image occlude the characters. If it is determined that the image includes a text overlay, the method proceeds to operation 612, where it is determined that the image is not croppable. If not, the method proceeds to operation 610.

At operation 610, it is determined that the image is croppable. In some aspects, suggestions that include a cropped version of the image are generated.

At operation 612, it is determined that the image is not croppable. In some aspects, suggestions that include a cropped version of the image are avoided. Instead, suggestions that do not require cropping the image are generated instead.

As with all of the methods described herein, aspects of the method 600 are possible that do not include all of the described operations. For example, some aspects do not include operations 606 and 608; instead, in those aspects, if it is determined that an image is a photograph at operation 608, the method 600 proceeds directly to operation 610 where it is determined that the image is croppable. Additionally, other aspects are possible as well that include one of but not both of operations 606 and 608.

FIG. 7 illustrates a method 700 for determining whether an image is a photograph. As an example, the method 700 may be executed by a component of an exemplary system such as the system 100. For example, the method 700 may be performed by the image analysis engine 110 to determine whether an image being analyzed is a photograph. In examples, the method 700 may be executed on a device comprising at least one processor configured to store and execute operations, programs, or instructions.

At operation 702, an image is received. In some aspects, the image is received from a content region of a content file for which the suggestion service 108 is generating suggestions. In other aspects, the image may be received from an image search application such as a search engine. Additionally, the image may be received from a web crawler application that analyzes web pages or social media content.

At operation 704, a statistical analysis based on pixels from the received image is generated. In some aspects, all of the pixels of the received image are used to generate the statistical analysis. In other aspects, a sampling of the pixels in the received image is used to perform statistical analysis. Further, in some aspects, the received image is divided into regions which may or may not overlap. The regions are then used to generate separate statistical analyses of the image. Beneficially, by dividing the image into regions, the impact of a uniform region such as a border or patch of sky or sea will be localized to the regions containing the uniform region. In these aspect, the statistical analysis for the other regions will not be affected by the uniformity (which otherwise might lead to an incorrect determination that the image is not a photograph). Various techniques may be used to perform the statistical analysis. For example, in some aspects, one or more lists of the unique colors that appear in the image or regions of the image are generated. As another example, one or more histograms may be generated for the image or regions of the image. As described in greater detail herein, a histogram may comprise a count of the number of times each color appears in the image (or region).

At operation 706, a score is calculated based on the statistical analysis. For example, in some aspects, the score is calculated by counting the number of unique colors in the image (or region). Alternatively, an entropy value is calculated based on one or more histograms. In some aspects, when multiple regions are being analyzed, a maximum score from the scores for the individual regions is selected as a score for the image.

At operation 708, the score is compared to a threshold. The threshold is selected based on the technique used for calculating the score. Additionally, the threshold may be selected based on the size of the image and/or the color format used to represent the image. In some aspects, machine learning techniques are used in conjunction with a corpus of training examples to determine an appropriate threshold.

At operation 710, the image is classified based on the comparison. For example, in some aspects, if the score exceeds the threshold, the image is classified as a photograph. At operation 712, appropriate suggestions are generated based on the classification. For example, if the image is classified as a photograph, blueprints that are configured to incorporate photographs (or placeholders for photographs) may be selected and used to generate suggestions.

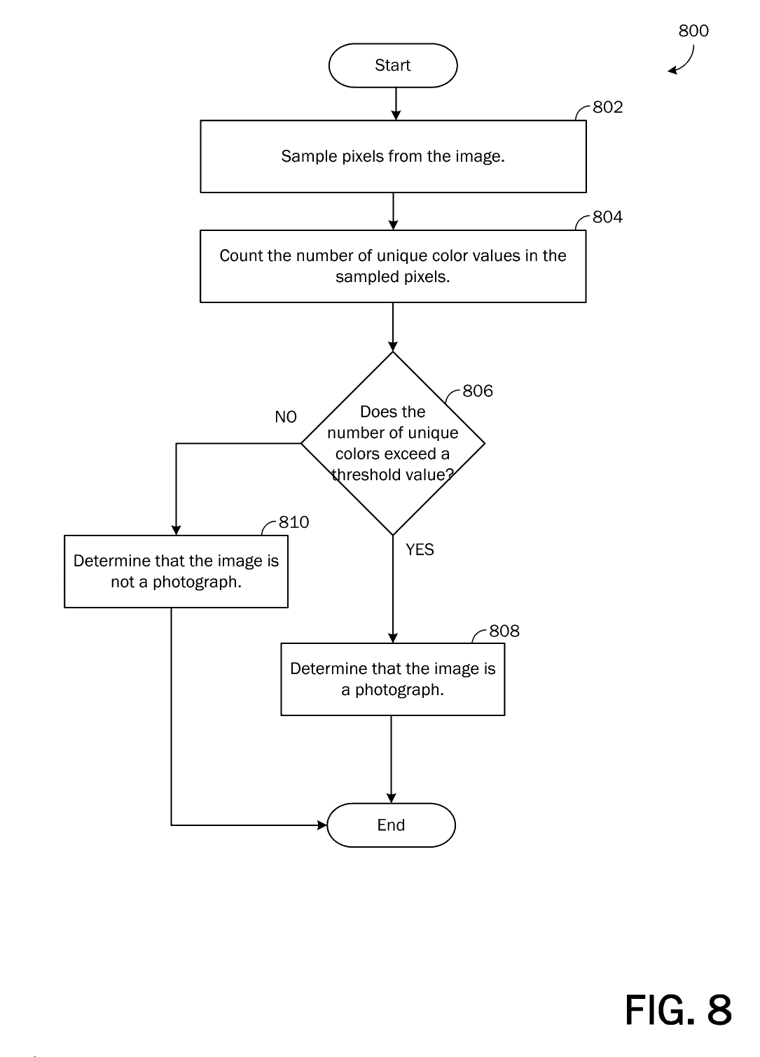

FIG. 8 illustrates another method 800 for determining whether an image is a photograph based on counting the number of unique pixels. As an example, the method 800 may be executed by a component of an exemplary system such as the system 100. For example, the method 800 may be performed by the image analysis engine 110 to determine whether an image being analyzed is a photograph. In examples, the method 800 may be executed on a device comprising at least one processor configured to store and execute operations, programs, or instructions.

At operation 802, pixels are sampled from the image. In some aspects, all of the pixels in the image are included in the sample. In other aspects, a portion of the pixels in the image are included in the sample. For example, every second pixel may be included in the sample. Alternatively, a different number such as every third, fourth, eighth, tenth, sixteenth, or any other number of pixels may be included in the sample. Further, in some aspects, pixels are randomly sampled from the image. For example, a predetermined number of pixels may be randomly selected for inclusion in the sample or a predetermined percentage of the total number of pixels may be randomly selected for inclusion in the sample. In aspects that sample a subset of the pixels in the image, the number of pixels that must be evaluated and the time required to perform the evaluations may be reduced.

At operation 804, the number of unique color values in the sampled pixels is counted. In some aspects, the image analysis engine iterates through the sampled pixels and tests whether the color value for the pixel is currently in a data structure such as a set. If the color value is not present, the color value is added to the data structure and a counter is incremented. Alternatively, after all of the color values have been added to the data structure, the number of elements in the data structure may be counted. The color values may be represented in any format for representing colors such as RGB, YCrCb, YUV, and other color representation formats. Generating the data structure that stores the color values is an example of generating a statistical analysis of the image. Calculating the count of unique colors is an example of calculating a score based on the statistical analysis.

At operation 806, it is determined whether the number of unique colors exceeds a threshold value. In some aspects, the threshold value is 2000. In other aspects, the threshold value may be higher or lower. For example, the threshold value may be selected from the ranges 1800-2200 or 1000-3000. In some aspects, the threshold value is set based on the number of pixels that are sampled. In these aspects, a lower threshold is used when fewer pixels are sampled and a higher threshold is used when more pixels are sampled. Additionally, in some aspects, the threshold values are adjusted based on the number of colors that are used to represent the image. For example, a lower threshold is used with an 8-bit color space (256 colors) than is used when a 24-bit color space (over 16 million colors) is used. Additionally, machine learning techniques may be used to evaluate a corpus of training examples to determine a threshold value. If the number of unique colors exceeds the threshold value, the method 800 continues to operation 808, where it is determined that the image is a photograph. If instead, the number of unique colors does not exceed the threshold, the method 800 proceeds to operation 810, where it is determined that the image is not a photograph.

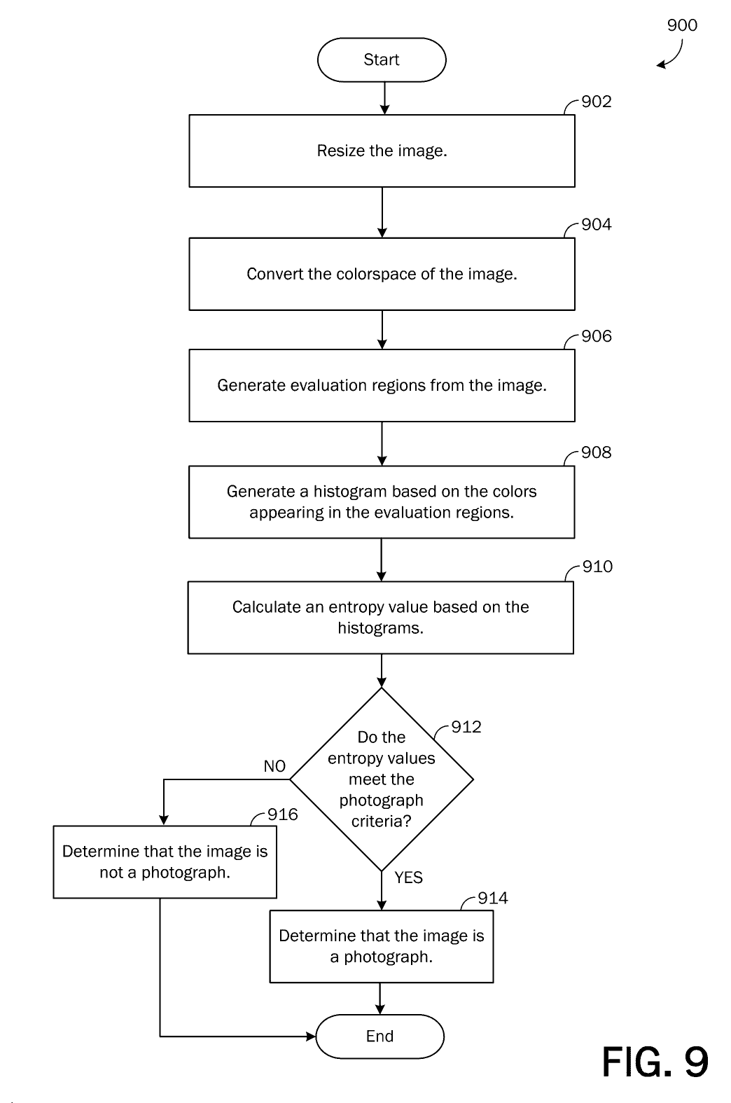

FIG. 9 illustrates another method 900 for determining whether an image is a photograph based on calculating an entropy value. As an example, the method 900 may be executed by a component of an exemplary system such as the system 100. For example, the method 900 may be performed by the image analysis engine 110 to determine whether an image being analyzed is a photograph. In examples, the method 900 may be executed on a device comprising at least one processor configured to store and execute operations, programs, or instructions.

At operation 902, the image is resized. In some aspects, the image is resized to a predetermined dimension. Further, in some aspects, the aspect ratio of the image is maintained during resizing. Alternatively, the aspect ratio is not maintained during resizing. Resizing the image may comprise applying various down sampling techniques such as selecting a single pixel to represent a group of multiple pixels, or averaging the values of a group of pixels to generate a single value. Depending on the size of the image, some aspects do not resize the image.

At operation 904, the color space of the image is converted. In some aspects the color space of the image is converted to a color space that has fewer values. For example, an image that is represented using a 24-bit color space (over 16 million colors) may be converted to an image that is represented with an 8-bit color space (256 colors). The conversion may be performed using standard techniques for mapping one color space to another. In some aspects, the image is converted to an 8-bit grayscale image based on the luminosity (i.e., brightness) values of the pixels. It should be understood that in these aspects the term color or color value refers to a grayscale color or color value.

At operation 906, evaluation regions are generated from the image. The evaluation regions represent at least a portion of the image. In various aspects, various numbers of evaluation regions are generated. For example, in some aspects, a single evaluation region comprising the entire image is generated. Other aspects generate multiple evaluation regions. In some aspects, the evaluation regions overlap one another. For example, five evaluation regions are generated in some aspects by dividing the image into quadrants and then generating one additional evaluation region from the center of the image that overlaps a portion of the four quadrants.

At operation 908, one or more histograms are generated based on the colors appearing in the evaluation regions. In some aspects, the histogram is a data structure that counts the number of pixels having each color value that appears in the region. As noted previously, the color value may be a grayscale color value. Although the histogram can be represented visually as a bar graph, not all aspects actually generate a visual representation of the histogram. Instead, some aspects store the histogram in a data structure such as an array or an associative array. The color values are used as keys to the array or associative array and the number of occurrences of the color value are stored as the values in the array or associative array. In some aspects, an 8-bit grayscale color value for the pixel is used as the key to the array. The histogram may be generated by iterating through each of the pixels in the region and incrementing the value associated with the color of the pixel. Generating the histograms is an example of generating a statistical analysis of the image.

At operation 910, one or more entropy values are calculated based on the histograms. In some aspects, the entropy for each region is calculated according to equation 1 below.

Eⱼ=−1*Σᵢ₌₁ⁿ(pᵢ*log₂(pᵢ)); Equation 1:

where
Eⱼ is the entropy of the jth region;
i is a key (e.g., a pixel color value, including a grayscale value) for the histogram for the jth region;
pᵢ is the value (e.g., the number of pixels) stored in the histogram for the key i; and
n is the total number of color values (e.g., RGB values, grayscale values, etc.) in the histogram.
   In other aspects, other equations may be used to calculate the entropy value as well. After the entropy value is calculated for each of the regions, the maximum entropy value may be selected as the entropy value for the image as a whole. Calculating the entropy values is an example of calculating a score based on the statistical analysis.

At operation 912, the entropy values are compared to the photograph criteria. In some aspects, the maximum entropy value is compared to a threshold value. In these aspects, if the maximum entropy value is equal to or exceeds the threshold value, the entropy values meet the photograph criteria. In some aspects, the threshold value is 6.7. Other aspects use higher or lower threshold values. For example, some aspects use a threshold value selected from the ranges of 6-7 or 4-9. Additionally, machine learning techniques may be used to evaluate a training example to determine a threshold value.

If the entropy values meet the photograph criteria, the method 900 continues on to operation 914, where it is determined that the image is a photograph. If instead, the entropy values do not meet the photograph criteria, the method 900 proceeds to operation 916, where it is determined that the image is not a photograph.

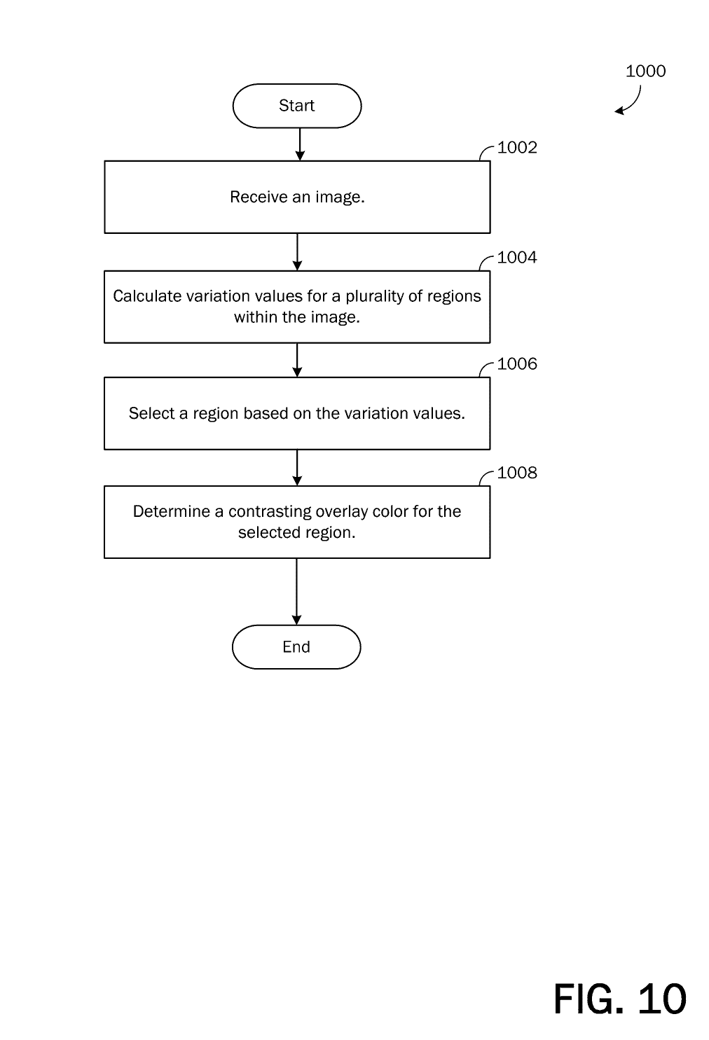

FIG. 10 illustrates a method 1000 for identifying an invariant region within an image. As an example, the method 1000 may be executed by a component of an exemplary system such as the system 100. For example, the method 1000 may be performed by the image analysis engine 110 to identify regions within an image that is being analyzed where text may be placed directly on the image. In examples, the method 1000 may be executed on a device comprising at least one processor configured to store and execute operations, programs, or instructions.

At operation 1002, an image is received. In some aspects, the image is received from a content region of a content file for which the suggestion service 108 is generating suggestions.

At operation 1004, variation values for a plurality of regions within an image are calculated. The variation values may be calculated based on determining a maximum distance between a pair of colors within a region. Additionally, in some aspects, the variation value is calculated based on an entropy value for the region. The distance value for the colors may be determined directly using the color values. Alternatively, the distance value may be calculated based on a luminance (i.e., brightness) value for the pixels. The luminance value for a pixel can be calculated from the color value for the pixel.

Various techniques may be used to determine regions for which to calculate variation values. For example, the image may be divided into a plurality of uniform shaped regions, such as blocks of pixels. When regions with low variation scores are adjacent to each other, they may be combined to potentially form larger regions of low variation. Additionally, in some aspects, regions may start with an initial size that is expanded by adding additional pixels (e.g., one or more rows or columns of pixels) as long as the variation value remains low enough (e.g., below a threshold value).

At operation 1006, a region is selected based on the variation values. In some aspects, the region is selected based on being associated with the lowest variation value. In some aspects, the region is selected based on the size of the region as well as the variation value.

At operation 1008, a contrasting overlay color is determined for the selected region. The contrasting overlay color may be determined based on identifying an average color for the region and selecting a contrasting color. Additionally, in some aspects, the contrasting overlay color is determined in part by calculating an average luminance of the region. When the luminance indicates that the invariant region is bright, a dark color is selected. Similarly, when the luminance indicates that the invariant region is dark, a bright color is selected. In these aspects, the chrominance (hue) of the color value of the contrasting overlay color may be selected based on a theme associated with the content region or selected blueprint while the luminance value of the contrasting overlay value is selected based on the luminance of the invariant region.

Beneficially, by identifying invariant regions and contrasting overlay values, suggestions may be generated that include text overlays on the image. In some aspects, the suggestions include text overlays that are placed directly over the image (i.e., the text overlay is not placed on a design element such as a rectangle with a contrasting background). In this manner, suggestions are generated that are visually appealing and are customized to fit the received image. In some aspects, multiple invariant regions are identified and suggestions are generated with multiple text overlays in those multiple regions. Further, in some aspects, multiple invariant regions are generated that have different overlay values. In some of these aspects, a text overlay will be generated in the invariant region associated with an overlay value that most closely matches a theme or style of the content region.

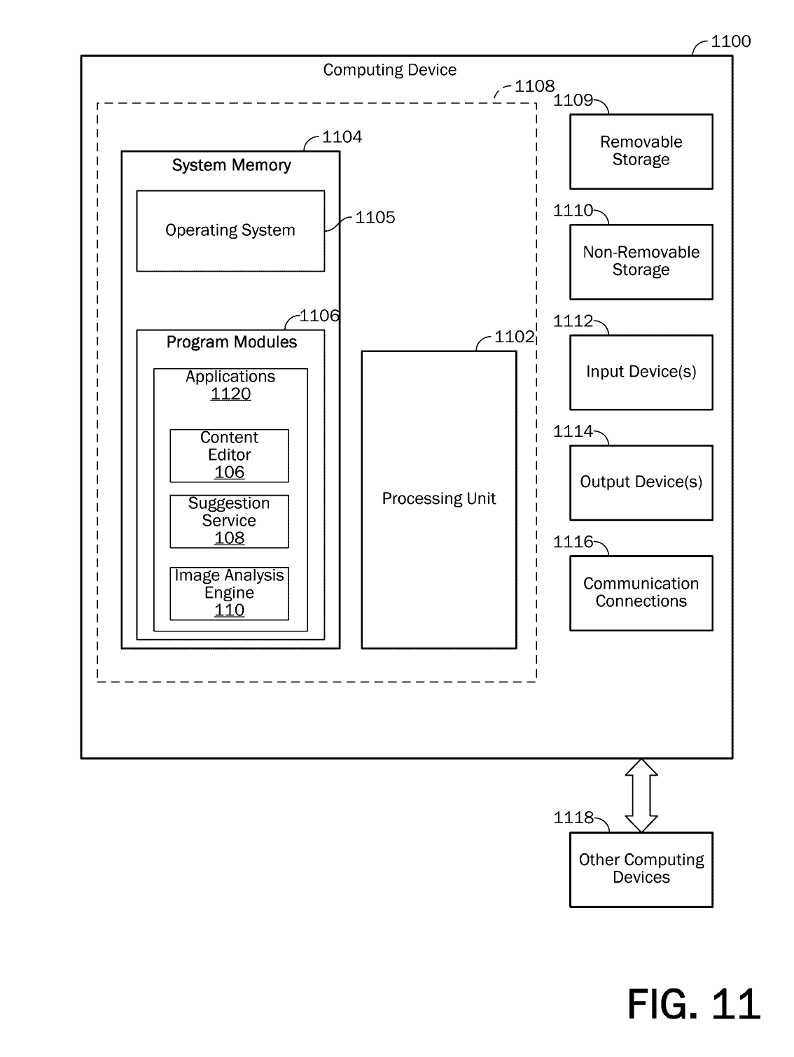

FIGS. 11-13 and the associated descriptions provide a discussion of a variety of operating environments in which aspects of the invention may be practiced. However, the devices and systems illustrated and discussed with respect to FIGS. 11-13 are for purposes of example and illustration and are not limiting of a vast number of computing device configurations that may be used for practicing aspects of the invention, described herein.

FIG. 11 is a block diagram illustrating physical components (i.e., hardware) of a computing device 1100 with which aspects of the invention may be practiced. The computing device components described below may be suitable for the user computing device 102 and the server computing device 104. In a basic configuration, the computing device 1100 may include at least one processing unit 1102 and a system memory 1104. Depending on the configuration and type of computing device, the system memory 1104 may comprise, but is not limited to, volatile storage (e.g., random access memory), non-volatile storage (e.g., read-only memory), flash memory, or any combination of such memories. The system memory 1104 may include an operating system 1105 and one or more program modules 1106 suitable for running software applications 1120 such as the content editor 106, the suggestion service 108, and the image analysis engine 110. The operating system 1105, for example, may be suitable for controlling the operation of the computing device 1100. Furthermore, aspects of the invention may be practiced in conjunction with a graphics library, other operating systems, or any other application program and is not limited to any particular application or system. This basic configuration is illustrated in FIG. 11 by those components within a dashed line 1108. The computing device 1100 may have additional features or functionality. For example, the computing device 1100 may also include additional data storage devices (removable and/or non-removable) such as, for example, magnetic disks, optical disks, or tape. Such additional storage is illustrated in FIG. 11 by a removable storage device 1109 and a non-removable storage device 1110.

As stated above, a number of program modules and data files may be stored in the system memory 1104. While executing on the processing unit 1102, the program modules 1106 (e.g., the content editor 106) may perform processes including, but not limited to, one or more of the stages of the methods 300-1000 illustrated in FIGS. 3-10. Other program modules that may be used in accordance with aspects of the present invention may include electronic mail and contacts applications, word processing applications, spreadsheet applications, database applications, slide presentation applications, drawing or computer-aided application programs, etc.

Furthermore, aspects of the invention may be practiced in an electrical circuit comprising discrete electronic elements, packaged or integrated electronic chips containing logic gates, a circuit utilizing a microprocessor, or on a single chip containing electronic elements or microprocessors. For example, aspects of the invention may be practiced via a system-on-a-chip (SOC) where each or many of the components illustrated in FIG. 11 may be integrated onto a single integrated circuit. Such an SOC device may include one or more processing units, graphics units, communications units, system virtualization units, and various application functionality all of which are integrated (or “burned”) onto the chip substrate as a single integrated circuit. When operating via an SOC, the functionality, described herein, with respect to the content editor 106, suggestion service 108, or image analysis engine 110 may be operated via application-specific logic integrated with other components of the computing device 1100 on the single integrated circuit (chip). Aspects of the invention may also be practiced using other technologies capable of performing logical operations such as, for example, AND, OR, and NOT, including but not limited to mechanical, optical, fluidic, and quantum technologies. In addition, aspects of the invention may be practiced within a general purpose computer or in any other circuits or systems.

The computing device 1100 may also have one or more input device(s) 1112 such as a keyboard, a mouse, a pen, a sound input device, a touch input device, etc. The output device(s) 1114 such as a display, speakers, a printer, etc. may also be included. The aforementioned devices are examples and others may be used. The computing device 1100 may include one or more communication connections 1116 allowing communications with other computing devices 1118. Examples of suitable communication connections 1116 include, but are not limited to, radio frequency (RF) transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 1104, the removable storage device 1109, and the non-removable storage device 1110 are all computer storage media examples (i.e., memory storage.) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 1100. Any such computer storage media may be part of the computing device 1100. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

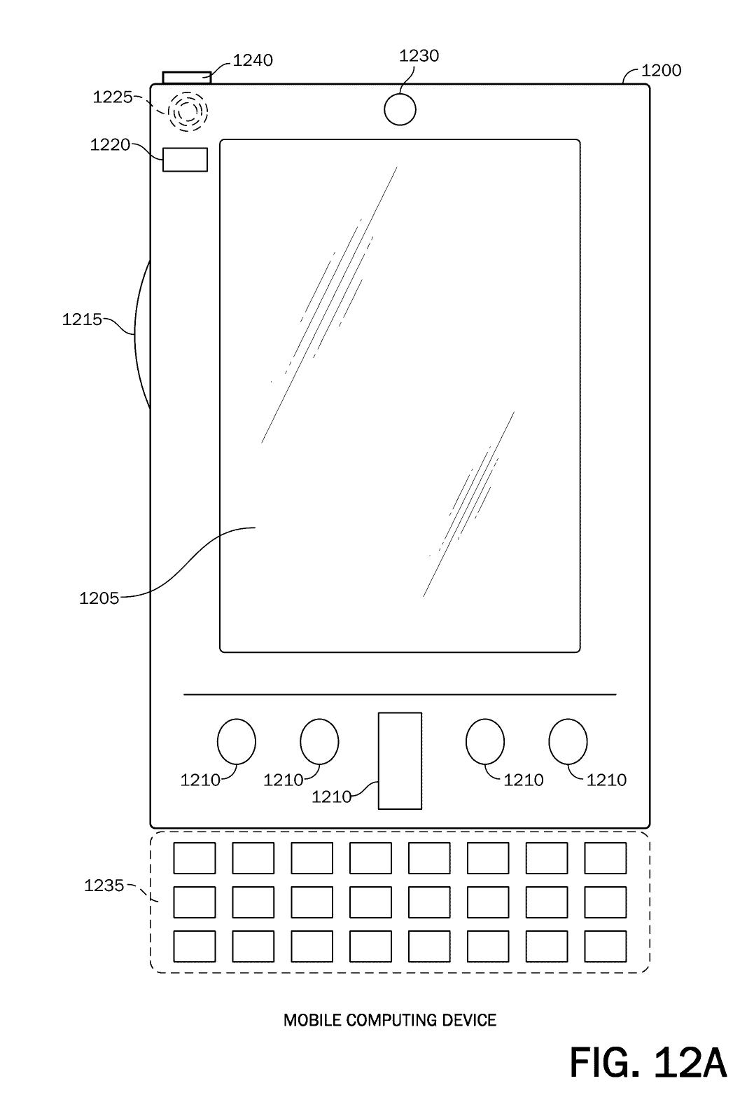

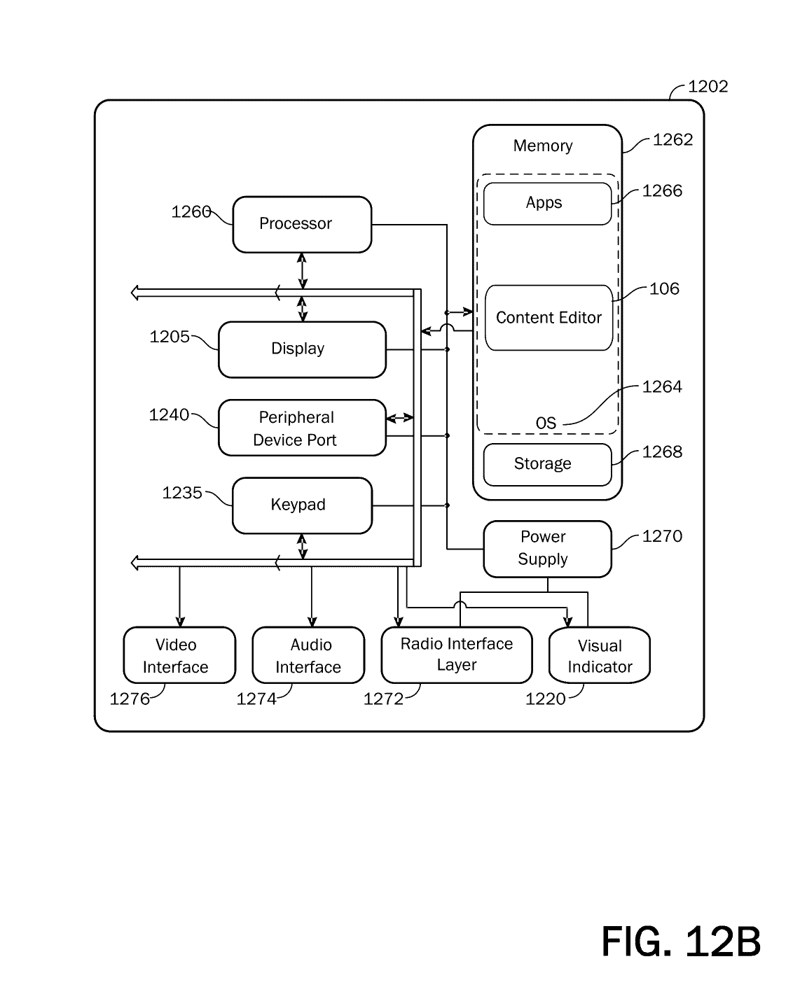

FIGS. 12A and 12B illustrate a mobile computing device 1200, for example, a mobile telephone, a smart phone, a tablet personal computer, a laptop computer, and the like, with which aspects of the invention may be practiced. With reference to FIG. 12A, one aspect of a mobile computing device 1200 for implementing the aspects is illustrated. In a basic configuration, the mobile computing device 1200 is a handheld computer having both input elements and output elements. The mobile computing device 1200 typically includes a display 1205 and one or more input buttons 1210 that allow the user to enter information into the mobile computing device 1200. The display 1205 of the mobile computing device 1200 may also function as an input device (e.g., a touch screen display). If included, an optional side input element 1215 allows further user input. The side input element 1215 may be a rotary switch, a button, or any other type of manual input element. In alternative aspects, mobile computing device 1200 may incorporate more or less input elements. For example, the display 1205 may not be a touch screen in some aspects. In yet another alternative aspect, the mobile computing device 1200 is a portable phone system, such as a cellular phone. The mobile computing device 1200 may also include an optional keypad 1235. Optional keypad 1235 may be a physical keypad or a “soft” keypad generated on the touch screen display. In various aspects, the output elements include the display 1205 for showing a graphical user interface (GUI), a visual indicator 1220 (e.g., a light emitting diode), and/or an audio transducer 1225 (e.g., a speaker). In some aspects, the mobile computing device 1200 incorporates a vibration transducer for providing the user with tactile feedback. In yet another aspect, the mobile computing device 1200 incorporates input and/or output peripheral device ports 1240, such as an audio input (e.g., a microphone jack), an audio output (e.g., a headphone jack), and a video output (e.g., a HDMI port) for sending signals to or receiving signals from an external device.

FIG. 12B is a block diagram illustrating the architecture of one aspect of a mobile computing device. That is, the mobile computing device 1200 can incorporate a system (i.e., an architecture) 1202 to implement some aspects. In one aspect, the system 1202 is implemented as a “smart phone” capable of running one or more applications (e.g., browsers, e-mail applications, calendaring applications, contact managers, messaging clients, games, and media clients/players). In some aspects, the system 1202 is integrated as a computing device, such as an integrated personal digital assistant (PDA) and wireless phone.

The system includes a processor 1260. One or more application programs 1266 may be loaded into the memory 1262 and run on or in association with the operating system 1264 using the processor 1260. Examples of the application programs include phone dialer programs, e-mail programs, personal information management (PIM) programs, word processing programs, spreadsheet programs, Internet browser programs, messaging programs, and so forth. The system 1202 also includes a non-volatile storage area 1268 within the memory 1262. The non-volatile storage area 1268 may be used to store persistent information that should not be lost if the system 1202 is powered down. The application programs 1266 may use and store information in the non-volatile storage area 1268, such as e-mail or other messages used by an e-mail application, and the like. As should be appreciated, other applications may be loaded into the memory 1262 and run on the mobile computing device 1200, including the content editor 106 described herein.

The system 1202 has a power supply 1270, which may be implemented as one or more batteries. The power supply 1270 might further include an external power source, such as an AC adapter or a powered docking cradle that supplements or recharges the batteries.

The system 1202 may also include a radio 1272 that performs the function of transmitting and receiving radio frequency communications. The radio 1272 facilitates wireless connectivity between the system 1202 and the “outside world,” via a communications carrier or service provider. Transmissions to and from the radio 1272 are conducted under control of the operating system 1264. In other words, communications received by the radio 1272 may be disseminated to the application programs 1266 via the operating system 1264, and vice versa.

The audio interface 1274 is used to provide audible signals to and receive audible signals from the user. For example, in addition to being coupled to the audio transducer 1225, the audio interface 1274 may also be coupled to a microphone to receive audible input, such as to facilitate a telephone conversation. The system 1202 may further include a video interface 1276 that enables an operation of an on-board camera 1230 to record still images, video streams, and the like.

A mobile computing device 1200 implementing the system 1202 may have additional features or functionality. For example, the mobile computing device 1200 may also include additional data storage devices (removable and/or non-removable) such as, magnetic disks, optical disks, or tape. Such additional storage is illustrated in FIG. 12B by the non-volatile storage area 1268.

Data/information generated or captured by the mobile computing device 1200 and stored via the system 1202 may be stored locally on the mobile computing device 1200, as described above, or the data may be stored on any number of storage media that may be accessed by the device via the radio 1272 or via a wired connection between the mobile computing device 1200 and a separate computing device associated with the mobile computing device 1200, for example, a server computer in a distributed computing network, such as the Internet. As should be appreciated such data/information may be accessed via the mobile computing device 1200 via the radio 1272 or via a distributed computing network. Similarly, such data/information may be readily transferred between computing devices for storage and use according to well-known data/information transfer and storage means, including electronic mail and collaborative data/information sharing systems.

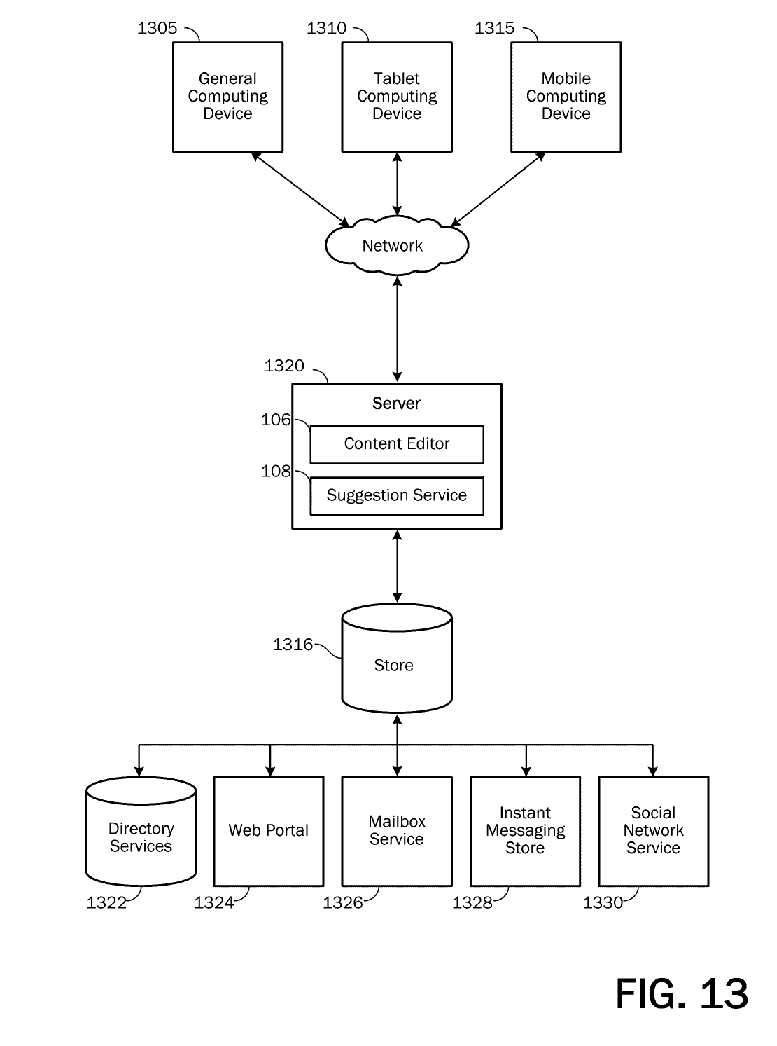

FIG. 13 illustrates one aspect of the architecture of a system for generating suggestions for a content file based on image analysis, as described above. Content files developed, interacted with, or edited in association with the content editor 106 or suggestion service 108 may be stored in different communication channels or other storage types. For example, various content files may be stored using a directory service 1322, a web portal 1324, a mailbox service 1326, an instant messaging store 1328, or a social networking service 1330. The content editor 106 or suggestion service 108 may access content files using any of these types of systems or the like, as described herein. A server 1320 may provide the content editor 106 or suggestion service 180 to clients. As one example, the server 1320 may be a web server providing the content editor 106 or suggestion service 180 over the web. The server 1320 may provide the content editor 106 or suggestion service 180 over the web to clients through a network. By way of example, the client computing device may be implemented as the computing device 1200 and embodied in a personal computer 1305, a tablet computing device 1310, and/or a mobile computing device 1315 (e.g., a smart phone). Any of these aspects of the client computing device 1305, 1310, 1315 may use the content editor 106 or suggestion service 108 to interact with content files stored in the store 1316.

Aspects of the present invention, for example, are described above with reference to block diagrams and/or operational illustrations of methods, systems, and computer program products according to aspects of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the invention as claimed in any way. The aspects, examples, and details provided in this application are considered sufficient to convey possession and enable others to make and use the best mode of claimed invention. The claimed invention should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed invention.

We claim:

1. A system for generating suggestions for arranging content based on understanding the contents of an image, the system comprising:
at least one processor; and
memory, operatively connected to the at least one processor and storing instructions that, when executed by the at least processor, cause the at least one processor to perform a method for generating suggestions for arranging content based on understanding the contents of an image, the method comprising:
receiving a content file, the content file including a content region and an image;
generating a statistical analysis of the image;
calculating a score based on the statistical analysis;
classifying the image based on comparing the score to a threshold value; and
generating a suggestion for arranging the content region based on the classification of the image.

2. The system of claim 1, wherein generating a statistical analysis of the image comprises:
identifying a plurality of regions of the image;
generating a statistical analysis of each of the plurality of regions; and
generating a statistical analysis of the image based on the statistical analyses of the plurality of regions.

3. The system of claim 2, wherein at least one of the regions of the plurality of regions overlaps at least one other region of the plurality of regions.

4. The system of claim 2, wherein generating a statistical analysis of the image based on the statistical analyses of the plurality of regions comprises selecting a statistical analysis from the plurality of regions as the statistical analysis for the image.

5. The system of claim 2, wherein generating a statistical analysis of the image based on the statistical analyses of the plurality of regions comprises averaging the statistical analyses from the plurality of regions to generate the statistical analysis for the image.

6. The system of claim 1, wherein the image comprises a two-dimensional array of pixels and each pixel is associated with a value corresponding to a visual property of the pixel.

7. The system of claim 6, wherein generating a statistical analysis of the image comprises:
selecting a plurality of sample pixels from the two-dimensional array of pixels; and
generating the statistical analysis of the plurality of sample pixels.

8. The system of claim 7, wherein the plurality of sample pixels are selected randomly from the two-dimensional array of pixels.

9. The system of claim 6, wherein the statistical analysis comprises counting a number of unique values associated with pixels in the two-dimensional array.

10. The system of clam 6, wherein the statistical analysis comprises generating a histogram based on values from at least some of the pixels, wherein the histogram comprises a set of values from the at least some of the pixels and the number of times each value in the set of values occurs in the at least some of the pixels.

11. The system of claim 10, wherein calculating a score based on the statistical analysis comprises calculating an entropy value from the generated histogram.

12. The system of claim 1, wherein the method further comprises:
identifying an invariant region of the image; and
determining an overlay color value for the invariant region.

13. The system of claim 12, wherein the invariant region comprises a region of the image in which a color value does not change by more than a predetermined amount.

14. The system of claim 12, wherein the invariant region comprises a region of the image in which a brightness value does not change by more than a predetermined amount.

15. A method for generating suggestions for arranging content based on understanding the contents of an image, the method comprising:
receiving a content file, the content file including a content region and an image;
generating, by a computing device, a statistical analysis of the image;
calculating a score based on the statistical analysis;
classifying the image based on comparing the score to a threshold value; and
generating a suggestion for arranging the content region based on the classification of the image.

16. The method of claim 18, wherein classifying the image comprises determining whether the image is a photograph or graphic.

17. The method of claim 16 further comprising when determined that the image is graphic, selecting a blueprint that is identified as being usable with graphics, and wherein generating a suggestion for arranging the content region based on the classification of the image comprises using the selected blueprint to generate a suggestion for arranging the content region.

18. The method of claim 16 further comprising:
when determined that the image is a photograph:
determining whether the image comprises a text overlay;
determining whether the image comprises a vignette;
determining whether the image is croppable based on whether the image comprises a vignette and whether the image comprises a text overlay.

19. A system for generating suggestions for arranging content based on understanding the contents of an image, the system comprising:
at least one processor; and
memory, operatively connected to the at least one processor and storing instructions that, when executed by the at least processor, cause the at least one processor to perform a method for generating suggestions for arranging content based on understanding the contents of an image, the method comprising:
receiving a content file, the content file including a content region and an image;
generating a statistical analysis of the image;
calculating a score based on the statistical analysis;
classifying the image based on comparing the score to a threshold value;
identifying an invariant region of the image;
determining an overlay color value for the invariant region; and
generating a suggestion for arranging the content region based on the classification of the image, the suggesting including text disposed over the identified invariant region and displayed using the determined overlay color.

20. The system of claim 19, wherein the method further comprises:
determining whether the image includes a border; and
when determined that the image includes a border, removing the border.
